(19) United States
(12) Patent Application Publication
(10) Pub. No.: US 2006/0029312 A1
(43) Pub. Date: Feb. 9, 2006

(54) Hydrodynamic bearing device, motor and disc driving apparatus

(76) Inventors: Hiroyuki Kiriyama, Ozu-shi (JP); Takao Yoshitsugu, Kita-gun (JP); Takafumi Asada, Hirakata-shi (JP); Hiroaki Saito, Ozu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/194,551

(22) Filed: Aug. 2, 2005

(30) Foreign Application Priority Data
Aug. 6, 2004 (JP) 2004-231575

(51) Int. Cl. F16C 32/06

(52) U.S. Cl. 384/107

(57) ABSTRACT

An object of the present invention is to provide a hydrodynamic bearing device having a high reliability which can achieve miniaturization and reduction of weight and thickness, and a motor and a disc driving apparatus using the same. In the hydrodynamic bearing device according to the present invention, a sleeve through which a shaft penetrates has a first opposing surface substantially orthogonal to a central axis of the shaft at one end and has a second opposing surface at the other end. A thrust plate having a disc shape which is fixed near one end of the shaft or which is integrally formed with the shaft is positioned so as to oppose the first opposing surface of the sleeve. A seal plate positioned near the other end of the shaft is positioned with a gap to the second opposing surface of the sleeve.

### BACKGROUND OF THE INVENTION

1. Field of the Invention

The present invention relates to a hydrodynamic bearing device utilizing a dynamic pressure of a fluid which is used in motors and the like for rotationally driving a recording medium having a disc shape, and a motor and a disc driving apparatus using the hydrodynamic bearing device.

2. Description of the Related Art

Recently, disc driving apparatuses for rotationally driving recording media having a disc shape such as magnetic discs, optical discs, magneto-optical discs, and the like have increasingly more memory capacity and higher transfer rate of data. Thus, bearing devices of motors used in such disc driving apparatuses are hydrodynamic bearing devices which can hold axis of rapid rotational driving with a high precision.

In a typical hydrodynamic bearing device, oil which functions as a working fluid for lubrication is filled between an outer peripheral surface of a shaft and an inner peripheral surface of a holding portion which holds the shaft. A groove having a herringbone pattern, which generates dynamic pressure, is formed on the outer peripheral surface of the shaft or the inner peripheral surface of the holding portion. In this way, a radial bearing portion for supporting a load of a rotor in a radial direction during rotation is formed. Further, a lubricating oil is filled between a thrust plate having a disc shape, which is fixed to an end of the shaft, and the holding portion. A groove having a spiral pattern, which generates a dynamic pressure, is formed on one of surfaces of the thrust plate and the holding portion which oppose each other. In this way, a thrust bearing portion for supporting a load of a rotor in an axial direction during rotation is formed.

Hereinafter, a conventional hydrodynamic bearing device will be specifically described with reference to FIG. 7. FIG. 7 is a cross-sectional view showing a structure of a motor for a disc driving apparatus which uses a hydrodynamic bearing device disclosed in Japanese Laid-Open Publication No. 2000-350408.

As shown in FIG. 7, a conventional motor for a disc driving apparatus includes: a rotor hub 2 to which a recording medium 1 having a disc shape such as magnetic discs (hereinafter, referred to as disc 1) is attached; a shaft 3 which is provided so as to penetrate the rotor hub 2 in an axial direction; a base 4 for fixing the shaft 3 and holding a core 5 of a motor stator; and a rotor magnet 6 positioned so as to oppose the core 5 and fixed to the rotor hub 2. On an outer peripheral surface of the shaft 3 or an inner peripheral surface of the rotor hub 2, a groove having a herringbone pattern is formed. On a lower surface of the rotor hub 2 or an upper surface of the base 4, a groove having a spiral pattern is formed. Lubricating oil 7 is filled in a small gap between surfaces of the rotor hub 2 and the shaft 3 which oppose each other, and a radial bearing portion is formed. Further, lubricating oil 7 is filled in a small gap between surfaces of the rotor hub 2 and the base 4 which oppose each other, and a thrust bearing portion is formed.

As shown in FIG. 7, a notch 3a is formed in a top portion of the shaft 3. To the notch 3a, a plate 8 is fixed. The plate 8 has a ring shape protruding outward in a radial direction from the outer peripheral surface of the shaft 3. The plate 8 is positioned so as to correspond to a step portion 2a of the rotor hub 2 and has a function to retain the shaft 3.

In the motor for the disc driving apparatus which uses the conventional hydrodynamic bearing device which has the above-described structure, when a driving portion formed of the core 5 and the rotor magnet 6 is excited, the rotor hub 2 to which the disc 1 is attached is rotated, and bearing functions of the radial bearing portion and the thrust bearing portion are activated. Specifically, when the core 5 is energized, the rotor hub 2 is rotated with respect to the shaft 3 and the base 4. In the thrust bearing portion, the lubricating oil 7 between the lower surface of the rotor hub 2 and the upper surface of the base 4 generates a dynamic pressure and holds a load in the thrust direction. In the radial bearing portion, the lubricating oil 7 between the outer peripheral surface of the shaft 3 and the inner peripheral surface of the rotor hub 2 generates a dynamic pressure and holds a load in a radial direction.

Recent electronic equipment including disc driving apparatuses tend to be made smaller, lighter and thinner. This trend is particularly strong in portable electronic equipment. As a result, making motors for disc driving apparatuses used in such electronic equipment smaller, lighter and thinner is an important task in this field. Thus, miniaturization, and reduction in the weight and thickness of hydrodynamic bearing devices used as bearing devices in such motors for disc driving apparatuses are also tasks which have to be tackled.

In a motor for a disc driving apparatus using the conventional hydrodynamic bearing device, as described above, the thick base 4 for fixing the shaft 3 is provided under the rotor hub 2 to which the disc 1 is attached. Above the rotor hub 2, the ring plate 8 fixed to the shaft 3 has to be attached in order to retain the rotor hub 2. As described above, in the conventional motors for disc driving apparatuses, thick and heavy base 4 is used and a space for positioning a retaining member has to be reserved in particular. Such problems inhibit miniaturization and reduction of the weight and thickness of the hydrodynamic bearing devices and the motors for disc driving apparatuses.

An object of the present invention is to provide a hydrodynamic bearing device having a high reliability which can achieve miniaturization and reduction of the weight and thickness, and a motor and a disc driving apparatus using the same.

### SUMMARY OF THE INVENTION

In order to achieve the above-described object, a hydrodynamic bearing device comprises, as recited in claim 1: a shaft; a sleeve through which the shaft penetrates, which has a first opposing surface substantially orthogonal to a central axis of the shaft at one end and a second opposing surface at the other end, which has at least one communication path between the first opposing surface and the second opposing surface, and which is relatively rotatable with respect to the shaft; a thrust plate having a disc shape which is fixed near one end of the shaft or which is integrally formed with the shaft and which has a first surface opposing the first opposing surface of the sleeve; a seal plate which is positioned near other end of the shaft and which is integrally rotatable with the sleeve having a gap to the second opposing surface of the sleeve; a retaining portion which is fixed to the sleeve and is positioned so as to oppose a second surface of the thrust plate, which is an end surface opposite to the first surface; a radial direction dynamic pressure generating portion which is formed on at least one of the surfaces of the shaft and the sleeve which oppose each other; a thrust direction dynamic pressure generating portion which is formed on at least one of the surfaces of the thrust plate and the sleeve which oppose each other; and a lubricant which is held in a small gap of the radial direction dynamic pressure generating portion and the thrust direction dynamic pressure generating portion.

The hydrodynamic bearing device of the present invention which has the above-described structure is a device with a high reliability which can achieve miniaturization and reduction of the weight and thickness.

In a hydrodynamic bearing device according to the present invention, as recited in claim 2, the sleeve of claim 1 may include a first member through which the shaft penetrates and a second member fixed to an outer peripheral surface of the first member, and at least one communication path which is substantially parallel to a central axis of the shaft may be formed between the first member and the second member.

In a hydrodynamic bearing device according to the present invention, as recited in claim 3, the sleeve of claim 1 may include a first member through which the shaft penetrates and a second member fixed to an outer peripheral surface of the first member and integrally formed with the retaining portion.

In a hydrodynamic bearing device according to the present invention, as recited in claim 4, a recessed portion may be formed on at least one of surfaces of the sleeve of claim 1 and the seal plate which oppose each other.

A motor according to the present invention comprises, as recited in claim 5: a shaft; a sleeve through which the shaft penetrates, which has a first opposing surface substantially orthogonal to a central axis of the shaft at one end and a second opposing surface at the other end, which has at least one communication path between the first opposing surface and the second opposing surface, and which is relatively rotatable with respect to the shaft; a thrust plate having a disc shape which is fixed near one end of the shaft or which is integrally formed with the shaft and which has a first surface opposing the first opposing surface of the sleeve; a base fixed to the one end of the shaft; a seal plate which is positioned near other end of the shaft and which is integrally rotatable with the sleeve having a gap to the second opposing surface of the sleeve; a retaining portion which is fixed to the sleeve and is positioned so as to oppose a second surface of the thrust plate, which is an end surface opposite to the first surface; a radial direction dynamic pressure generating portion which is formed on at least one of the surfaces of the shaft and the sleeve which oppose each other; a thrust direction dynamic pressure generating portion which is formed on at least one of the surfaces of the thrust plate and the sleeve which oppose each other; a lubricant which is held in a small gap of the radial direction dynamic pressure generating portion and the thrust direction dynamic pressure generating portion; a motor rotor portion substantially fixed to the sleeve; and a motor stator portion positioned so as to oppose the motor rotor portion and fixed to the base.

The motor of the present invention which has the above-described structure can achieve miniaturization and reduction of the weight and thickness.

In a motor according to the present invention, as recited in claim 6, a base formed by pressing a metal plate may be formed to have a bent portion so as to function as a rib for improving rigidity.

In a motor according to the present invention, as recited in claim 7, a bent portion may be formed near a portion of the base fixed to the shaft and at least a part of the retaining portion may be positioned in a space formed by the bent portion.

In a motor according to the present invention, as recited in claim 8, the base may be fixed to the one end of the shaft by a fixing portion, a bent portion may be formed near a portion of the base which is fixed to the shaft, and at least a part of the portion which is fixed to the shaft may be positioned in a recessed space formed by the bent portion such that the fixing portion is not protruded outside the motor from a surface formed by the base.

In a motor according to the present invention, as recited in claim 9, the motor rotor portion may be a magnet and the motor stator portion may be a core.

In a motor according to the present invention, as recited in claim 10, the motor rotor portion of claim 9 may be positioned near the base such that a magnetic attraction of the motor rotor portion generate a suction force toward the base.

In a motor according to the present invention, as recited in claim 11, the motor rotor portion and the motor stator portion of claim 9 may be in offset positions such that the motor rotor portion is sucked toward the base.

In a motor according to the present invention, as recited in claim 12, the sleeve of claim 5 may include a first member through which the shaft penetrates and a second member fixed to the outer peripheral surface of the first member and integrally formed with the retaining portion.

A disc driving apparatus according to the present invention comprises, as recited in claim 13: a shaft; a sleeve through which the shaft penetrates, which has a first opposing surface substantially orthogonal to a central axis of the shaft at one end and a second opposing surface at the other end, which has at least one communication path between the first opposing surface and the second opposing surface, and which is relatively rotatable with respect to the shaft; a thrust plate having a disc shape which is fixed near one end of the shaft or which is integrally formed with the shaft and which has a first surface opposing the first opposing surface of the sleeve; a base fixed to the one end of the shaft and formed of a metal plate; a seal plate which is positioned near other end of the shaft and which is integrally rotatable with the sleeve having a gap to the second opposing surface of the sleeve; a retaining portion, which is fixed to the sleeve and is positioned so as to oppose a second surface of the thrust plate, which is an end surface opposite to the first surface; a radial direction dynamic pressure generating portion which is formed on at least one of the surfaces of the shaft and the sleeve which oppose each other; a thrust direction dynamic pressure generating portion which is formed on at least one of the surfaces of the thrust plate and the sleeve which oppose each other; a lubricant which is held in a small gap of the radial direction dynamic pressure generating portion and the thrust direction dynamic pressure generating portion; a hub which is fixed to an outer peripheral surface of the sleeve and to which a recording medium of a disc shape is attached; a motor rotor portion fixed to the hub; and a motor stator portion positioned so as to oppose the motor rotor portion and fixed to the base.

The disc driving apparatus of the present invention which has the above-described structure can achieve miniaturization and reduction of the weight and thickness.

In a disc driving apparatus according to the present invention, as recited in claim 14, an intermediate member may be provided between the sleeve and the hub, and the shaft, the sleeve, the thrust plate, the seal plate, the retaining portion, the radial direction dynamic pressure generating portion, the thrust direction dynamic pressure generating portion, and the lubricant may be integrally formed as a bearing member using the intermediate member.

In a disc driving apparatus according to the present invention, as recited in claim 15, the retaining portion and the hub may be integrally formed.

A method for producing a hydrodynamic bearing device according to the present invention comprises the steps of, as recited in claim 16: forming a radial direction dynamic pressure generating portion on at least one of surfaces of a shaft and a sleeve which oppose each other; forming a thrust direction dynamic pressure generating portion on at least one of surfaces of a thrust plate of a disc shape and the sleeve which oppose each other; inserting the sleeve so as to be relatively rotatable with respect to the shaft such that the first surface of the thrust plate orthogonal to a central axis of the shaft opposes a first opposing surface of the sleeve; positioning a retaining portion so as to oppose a second surface of the thrust plate which is an end surface opposite to the first surface and fixing the retaining portion to the sleeve; and positioning a seal plate which is integrally rotatable with the sleeve near the other end of the shaft having a gap to a second opposing surface of the sleeve which is an end surface opposite to the first opposing surface and fixing the seal plate to a hub fixed to an outer peripheral surface of the sleeve so as to be integrally rotatable with the sleeve.

According to the method for producing the hydrodynamic bearing device of the present invention which has the above-described steps, it becomes possible to readily form the radial direction dynamic pressure generating portion and the thrust direction dynamic pressure generating portion with high precisions, and also to achieve miniaturization and reduction of the weight and thickness of the hydrodynamic bearing device.

A method for producing a hydrodynamic bearing device according to the present invention comprises the steps of, as recited in claim 17: forming a radial direction dynamic pressure generating portion on at least one of surfaces of a shaft and a sleeve which oppose each other; forming a thrust direction dynamic pressure generating portion on at least one of surfaces of a thrust plate of a disc shape and the sleeve which oppose each other; positioning the shaft and the thrust plate provided near one end of the shaft inside a hub including a side portion which has a ring inner peripheral surface and a bottom portion which is provided on one end of the side portion and has a hole having a diameter smaller than that of the inner peripheral surface, with the one end of the shaft penetrating through the hole and a second surface of the thrust plate which is orthogonal to a central axis of the shaft opposing an axial direction surface of the bottom portion; fitting the sleeve in the ring inner peripheral surface of the hub such that the sleeve is penetrated from the side of the other end of the shaft, and a first opposing surface of the sleeve opposes a first surface of the thrust plate which is an end surface opposite to the second surface; and positioning a seal plate which is integrally rotatable with the sleeve near the other end of the shaft having a gap to a second opposing surface of the sleeve which is an end surface opposite to the first opposing surface and fixing the seal plate to the hub fixed to an outer peripheral surface of the sleeve so as to be integrally rotatable with the sleeve.

According to the method for producing the hydrodynamic bearing device of the present invention which has the above-described steps, it becomes possible to readily form the radial direction dynamic pressure generating portion and the thrust direction dynamic pressure generating portion with high precisions, and also to achieve miniaturization and reduction of the weight and thickness of the hydrodynamic bearing device.

According to the present invention, miniaturization and reduction of the weight and thickness can be achieved, and hydrodynamic bearing devices having high reliability, mass productivity, and operation efficiency, and motors and disc driving apparatuses using the same can be provided. Especially, when the shaft is integrally formed with the thrust plate, accuracy of parts such as squareness between the shaft and the thrust plate can be improved.

In the hydrodynamic bearing device according to the present invention, a base is formed by pressing a thin metal plate and a strengthening rib is provided in the base in order to improve the rigidity. Thus, the hydrodynamic bearing devices can be miniaturized and have reduced weight and thickness. Further, by using the hydrodynamic bearing devices according to the present invention, it becomes also possible to miniaturize and reduce the weight and thickness of the motors and the disc driving apparatuses.

In the hydrodynamic bearing device according to the present invention, an oil reserver is formed by positioning a seal plate on top of a sleeve. Since the oil reserver is connected to an opening, sufficient lubricating oil can be supplied when the rotation operation is performed, and bubbles generated during rotation can also be discharged. Further, a communication hole which is a path for communication between the oil reserver and a thrust direction dynamic pressure generating portion is formed in the sleeve. Thus, pressure adjustment of the thrust direction dynamic pressure generating portion is possible, and bubbles generated at the thrust direction dynamic pressure generating portion can be removed. Therefore, according to the present invention, a lifting property of a bearing portion is stabilized, and thus, the life of the bearing portion can be extended.

Further, in the hydrodynamic bearing device according to the present invention, a strengthening rib is provided on a base of a metal plate. A retaining portion fixed to the sleeve is positioned within an internal space formed by the strengthening rib. Thus, the internal space of the hydrodynamic bearing device can be efficiently used. Therefore, the apparatus can be miniaturized and can have reduced thickness.

In the method for producing the hydrodynamic bearing device according to the present invention, dynamic pressure generating groove can be formed on single members, for example, a shaft, sleeve, thrust plate and the like, before assembling. Thus, it is possible to readily and securely form the hydrodynamic bearing devices having high precisions at a high yield.

### BRIEF DESCRIPTION OF THE DRAWINGS

FIG. 1 is a cross-sectional view showing a motor for a disc driving apparatus which uses a hydrodynamic bearing device of Embodiment 1 according to the present invention.

FIGS. 2A through 2E are diagrams for illustrating a method for assembling the hydrodynamic bearing device of Embodiment 1 according to the present invention.

FIG. 3 is a cross-sectional view of a right half of a motor for a disc driving apparatus which uses a hydrodynamic bearing device of Embodiment 2 showing the structure thereof.

FIG. 4 is a plan view showing a shaft and a sleeve which form a bearing portion in the motor for the disc driving apparatus of Embodiment 2.

FIG. 5 is a cross-sectional view of a right half of a motor for a disc driving apparatus which uses a variant of the hydrodynamic bearing device of Embodiment 2 showing the structure thereof.

FIGS. 6A through 6D are diagrams illustrating a method for assembling the variant of the hydrodynamic bearing device of Embodiment 2.

FIG. 7 is a cross-sectional view of a motor which uses a conventional hydrodynamic bearing device.

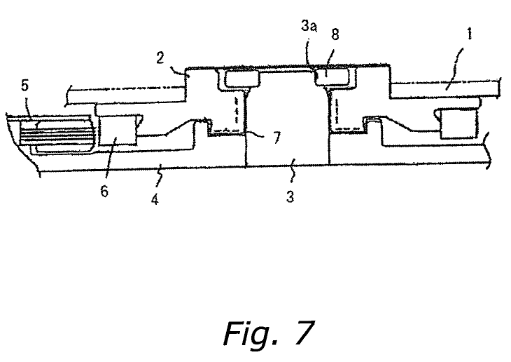

### DESCRIPTION OF THE PREFERRED EMBODIMENTS

Hereinafter, preferred embodiments of a hydrodynamic bearing device and a motor for a disc driving apparatus which uses the hydrodynamic bearing device according to the present invention will be described with reference to the drawings.

### Embodiment 1

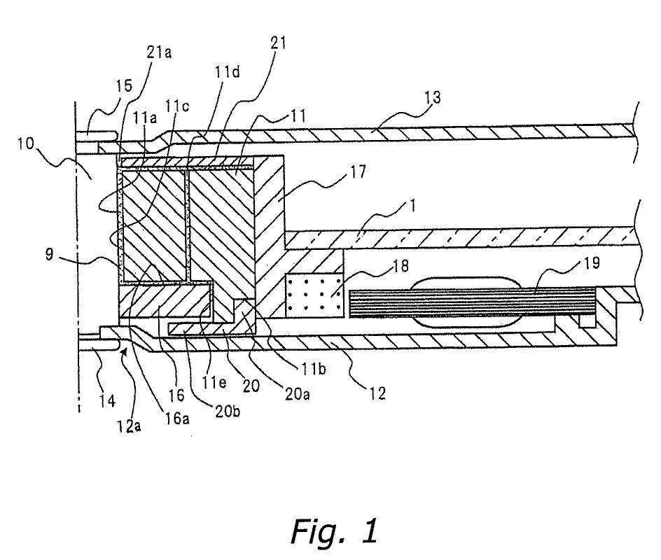

A motor for a disc driving apparatus which uses a hydrodynamic bearing device of Embodiment 1 according to the present invention will be described with reference to FIG. 1. FIG. 1 is a cross-sectional view showing a structure of the motor for the disc driving apparatus which uses the hydrodynamic bearing device of Embodiment 1. Since the hydrodynamic bearing device of Embodiment 1 has a substantially bilaterally-symmetrical shape, FIG. 1 shows only a right half of the hydrodynamic bearing device.

As shown in FIG. 1, a shaft 10 is inserted into a bearing hole 11a of a sleeve 11 so as to be rotatable with respect to the bearing hole 11a. To a lower part of the shaft 10, a thrust plate 16 having a disc shape is positioned. The thrust plate 16 is elongated in a direction orthogonal to the central axis, and is fitted within a recessed portion 11e formed in the sleeve 11. The thrust plate 16 is formed to hold the sleeve 11 which rotates. The lower end of the shaft 10 is fixed to a base 12 with a screw 14. To the upper end of the shaft 10, a cover 13 is attached with a screw 15.

On an outer peripheral surface of the sleeve 11, a rotor hub 17 is fixed. To the rotor hub 17, a recording medium 1 having a disc shape such as magnetic discs, optical discs, magneto-optical discs and the like (hereinafter, referred to as disc 1) is attached. A rotor magnet 18 is fixed to the rotor hub 17 under the disc 1 attached thereto (under refers to the side where the base 12 is provided). The rotor magnet 18 is provided so as to oppose a core 19 which is a stator of a motor portion which is fixed to the base 12.

As shown in FIG. 1, a step portion 11b is formed in a lower part of the outer peripheral portion of the sleeve 11. To the step portion 11b, a retaining plate 20 which has a ring shape and a cross-section bent by substantially 90 degrees is fixed. Specifically, a portion 20a of the retaining plate 20 which protrudes upward is located and fixed to the step portion 11b of the sleeve 11. A remaining portion 20b of the retaining plate 20 which protrudes toward the shaft is formed to be at a position opposing the lower surface of the thrust plate 16.

In the hydrodynamic bearing device of Embodiment 1, the base 12 is formed of a thin metal plate, for example, a steel plate having a thickness of about 0.3 mm by pressing. A step is formed where the base 12 is fixed to the shaft 10. This step functions as a strengthening rib 12a. Since the strengthening rib 12a is provided in the base 12, the rigidity of the base 12 can be improved. Also, it becomes possible to prevent the screw head from being protruded downward from the lower surface of the base 12 when the base 12 is fixed to the shaft 10 with the screw 14. Thus, the hydrodynamic bearing device of Embodiment 1 having the above-described structure has a simple external shape and can be easily designed to be incorporated into apparatuses.

In the hydrodynamic bearing device of Embodiment 1, since the base 12 of a metal plate is bent to form the strengthening rib 12a, a space is formed inside the apparatus above the upper surface of the base 12. In this space, the portion 20b of the retaining plate 20 which protrudes toward the shaft is positioned. As a result, in the structure of Embodiment 1, a space formed by the strengthening rib 12a of the base 12 serves as a space for positioning the retaining plate 20. Thus, members of the hydrodynamic bearing device can be arranged in the internal space of the hydrodynamic bearing device in an efficient manner, and it is possible to aim at miniaturizing and reducing the thickness.

In the hydrodynamic bearing device of Embodiment 1, a dynamic pressure generating groove 11c is formed on an inner peripheral surface of the bearing hole Ha of the sleeve 11. Further, a dynamic pressure generating groove 16a is formed on an upper surface of the thrust plate 16 which opposes the sleeve 11. Lubricating oil 9 as a work fluid for lubrication is held in a gap formed by surfaces of the shaft 10 and the sleeve 11 which oppose each other, and a gap formed by surfaces of the thrust plate 16 and the sleeve 11 which oppose each other, including a gap formed by surfaces on which the dynamic pressure generating grooves 11c and 16a are provided.

In the hydrodynamic bearing device of Embodiment 1, the dynamic pressure generating groove 11c is formed on the inner peripheral surface of the bearing hole 11a of the sleeve 11. However, the present invention is not limited to such a structure. A dynamic pressure generating groove may be formed on an outer peripheral surface of the shaft 10 which opposes the bearing hole 11a. Further, the dynamic pressure generating groove 16a is formed on the surface of the thrust plate 16 which opposes the sleeve 11. However, a dynamic pressure generating groove may be formed on a surface of the sleeve 11 which opposes the thrust plate 16.

The dynamic pressure generating groove 11c formed on the surfaces of the shaft 10 and the sleeve 11 which oppose each other forms a radial direction dynamic pressure generating portion. The dynamic pressure generating groove 16a formed on the surfaces of the thrust plate 16 and the sleeve 11 which oppose each other forms a thrust direction dynamic pressure generating portion.

A seal plate 21 is positioned so as to oppose an upper end surface (surface orthogonal to a rotation axis) of the sleeve 11. The seal plate 21 is fixed to an inner peripheral surface of the rotor hub 17. The inner peripheral end surface of the seal plate 21 and the outer peripheral surface of the shaft 10 are spaced apart by a predetermined distance, thereby forming an opening 21a. Therefore, the seal plate 21 is positioned so as to cover the upper end surface of the sleeve 11 with a predetermined gap (for example, a gap having a distance within the range of 0.02 to 0.1 mm) from the upper surface of the sleeve 11. In the sleeve 11, at least one communicating hole 11d elongated in parallel with the rotation axis is formed. The communicating hole 11d allows the gap between the sleeve 11 and the seal plate 21 to be in communication with the gap between the sleeve 11 and the thrust plate 16. Specifically, the communicating hole 11d is formed so as to allow communication between the upper end surface of the sleeve 11 and the surface of the sleeve 11 which opposes the thrust plate 16 (surface orthogonal to the rotation axis). In the sleeve 11, the surface which opposes the thrust plate 16 is a first opposing surface and the upper end surface is a second opposing surface.

In the seal plate 21 positioned as described above, a gap having a predetermined distance is formed between a lower surface of the seal plate 21 and an upper end surface of the sleeve 11 to serve as an oil reserver for the lubricating oil 9. Further, since the seal plate 21 has the inner peripheral end surface spaced apart from the outer peripheral surface of the shaft 10 by a predetermined distance to form the opening 21a, it has a function to discharge bubbles into air from the lubricating oil 9 which serves as a work fluid. Moreover, since the communication hole 11d formed in the sleeve 11 allows the oil reserver formed of the sleeve 11 and the seal plate 21 to be in communication with the thrust bearing portion formed of the surfaces of the sleeve 11 and the thrust plate 16 which oppose each other, it has a function to adjust a pressure of the thrust bearing.

Hereinafter, an operation of the motor for the disc driving apparatus which uses the hydrodynamic bearing device of Embodiment 1 having the above-described structure will be described.

In the apparatus shown in FIG. 1, when the core 19 which is the stator of the motor is energized, a rotating magnetic field is generated and the rotor magnet 18, the rotor hub 17 and the sleeve 11 start to rotate. At this time, the dynamic pressure generating groove 11c (radial bearing portion) formed on the bearing hole Ha of the sleeve 11 and the dynamic pressure generating groove 16a (thrust bearing portion) formed on the upper surface of the thrust plate 16 generate a pumping pressure in the lubricating oil 9. Thus, the sleeve 11 is lifted from the upper surface of the thrust plate 16 and is also held in a radial direction spaced apart from the outer peripheral surface of the shaft 10 with a predetermined gap therebetween. In this way, a rotor formed of the sleeve 11, the rotor hub 17, the rotor magnet 18, the retaining plate 20, the seal plate 21 and the disc 1 rotates with respect to the shaft 10 and the thrust plate 16 without contacting them.

While the shaft 10 is being rotated, it is lubricated with the lubricating oil 9 inside the oil reserver formed by a gap between the seal plate 21 and the sleeve 11. In this embodiment, since the oil reserver is placed on the end surface of the sleeve 11 located on the rotation side, large space above the upper surface of the sleeve 11 can be used. Though centrifugal force is applied to the lubricating oil 9 inside the oil reserver during rotation, the shortfall of the lubricating oil 9 inside the bearing portion is supplied at rest. The lubricating oil 9 is supplied sufficiently from the oil reserver, so the bearing life can be extended. Some of bubbles generated in the lubricating oil 9 during operation are discharged from the opening 21a between the inner peripheral end surface of the seal plate 21 and the outer peripheral surface of the shaft 10, and some remain inside the oil reserver.

In the motor for the disc driving apparatus which uses the hydrodynamic bearing device of Embodiment 1, the dynamic pressure generating groove 16a (thrust bearing portion) is formed on the surface of the thrust plate 16 which opposes the sleeve 11. This one thrust bearing portion rotatably holds the rotor in an axial direction (thrust direction). In the hydrodynamic bearing device of Embodiment 1, since the rotor is held in the axial direction (thrust direction) by one thrust bearing portion as described above, the rotor during rotation operation moves in a direction so as to be lifted from the thrust plate 16. However, in the hydrodynamic bearing device of Embodiment 1, the rotor is formed so as to be sucked toward the base by a magnetic attraction of the rotor magnet 18 toward the base 12 which is formed of a metal plate. Thus, the rotor rotates at a desired position with respect to the shaft 10. Further, a magnetic center of the rotor magnet 18, which is a rotor which forms the motor, and the core 19 which is a stator may be shifted such that they are in offset positions. This structure also allows the rotor to rotate at a desired position with respect to the shaft 10.

As described above, in the hydrodynamic bearing device of Embodiment 1, the rotor during rotation is at a desired position with respect to the shaft 10. Thus, the sleeve 11 and the retaining plate 20 do not contact the thrust plate 16 unnecessarily.

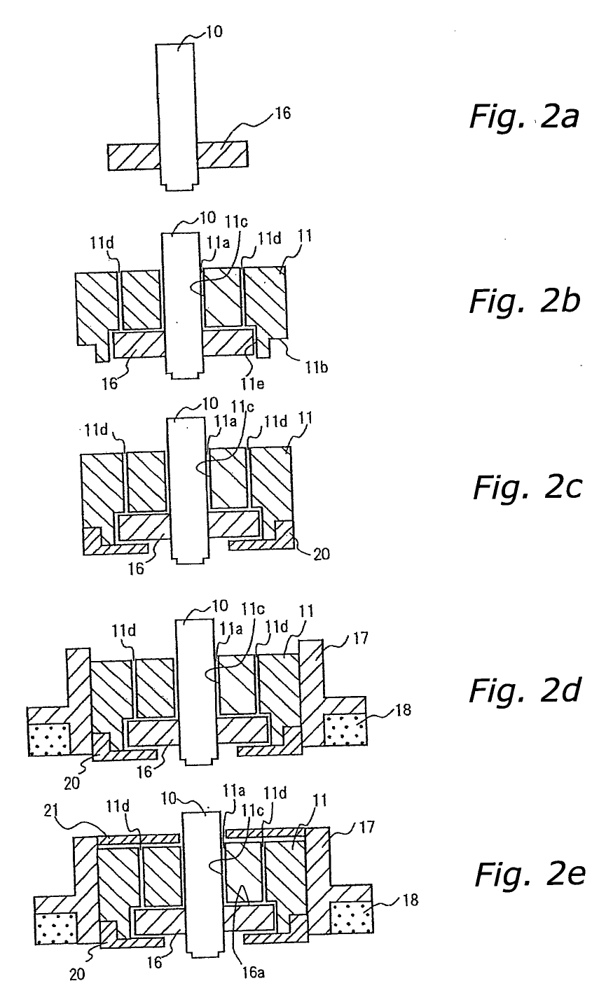

Next, a method for assembling the hydrodynamic bearing device of Embodiment 1 which has the above-described structure will be described with reference to FIGS. 2A through 2E.

FIGS. 2A through 2E are schematic views for illustrating a method for assembling the hydrodynamic bearing device of Embodiment 1. The hydrodynamic bearing device of Embodiment 1 is assembled as sequentially shown by FIGS. 2A through 2E. FIG. 2A shows the thrust plate 16 fixed to the shaft 10 by insertion (or press fit) and an adhesive. In some cases, the shaft 10 is integrally formed with the thrust plate 16. As shown in FIG. 2B, the shaft 10 with the thrust plate 16 fixed thereto is inserted into the bearing hole 11a of the sleeve 11. Then the retaining plate 20 is fixed to the step 11b formed at the lower end of the outer peripheral surface of the sleeve 11 by insertion and an adhesive (see FIG. 2C). The rotor magnet 18 is fixed to the rotor hub 17, and to an inner peripheral surface of the rotor hub 17, the sleeve 11 assembled as shown in FIG. 2C (including the shaft 10, thrust plate 16, and the retaining plate 20) is fixed by insertion and an adhesive (see FIG. 2D). Next, with a gap having a predetermined distance to the upper end surface of the sleeve 11 being secured, the seal plate 21 is fixed to a top portion of the inner peripheral surface of the rotor hub 17. Insertion and an adhesive may be used for fixing. The seal plate 21 may be fixed by applying an adhesive on a part of the inner peripheral surface of the rotor hub 17 and the upper end surface of the sleeve 11.

In the hydrodynamic bearing device assembled and produced as described above, the base 12 of a metal plate is fixed to the lower end of the shaft 10 with the screw 14. The disc 1 is attached to the rotor hub 17 and is fixed to the rotor hub 17 by a clamp member. Finally, the cover 13 is fixed to the upper end of the shaft 10 with the screw 15, and the motor for the disc driving apparatus which uses the hydrodynamic bearing device of Embodiment 1 is completed.

As described above, in the hydrodynamic bearing device and the motor for the disc driving apparatus which uses the hydrodynamic bearing device of Embodiment 1, the base 12 is formed by pressing using a thin metal plate, and the strengthening rib 12a is provided on the base 12 in order to improve the rigidity. Thus, the hydrodynamic bearing device can be miniaturized, and the weight and thickness thereof can be reduced. Further, by using such a hydrodynamic bearing device, the motor and the disc driving apparatus can also be miniaturized, and the weight and thickness thereof can also be reduced.

In Embodiment 1, the seal plate 21 is positioned above the sleeve 11 such that an oil reserver is formed. The oil reserver is connected to the opening 21a. Thus, a sufficient lubricant can be supplied during the rotating operation, and also, bubbles generated during rotation can be discharged. The communication hole 11d which allows the communication between the oil reserver and the thrust bearing portion is formed in the sleeve 11. Thus, pressure of the thrust bearing portion can be adjusted, and bubbles generated at the thrust bearing portion can be removed. Therefore, according to the structure of Embodiment 1, a lifting property of the bearing portion can be stabilized and the life of the bearing portion can be extended.

According to the method for producing the hydrodynamic bearing device of Embodiment 1, the dynamic pressure generating groove can be formed in single parts, for example, the shaft, the sleeve, the thrust plate and the like before assembling. Thus, the hydrodynamic bearing devices with high precisions can be readily and securely formed at a high yield.

In the hydrodynamic bearing device of Embodiment 1, the strengthening rib 12a is provided in the base 12 of a metal plate, and the retaining plate 20 fixed to the sleeve 11 is positioned in the internal space formed by the strengthening rib 12a. Thus, the internal space of the hydrodynamic bearing device can be used efficiently, and the arrangement can be miniaturized and have a reduced thickness.

In the hydrodynamic bearing device of Embodiment 1, the base 12 is formed by pressing a metal plate, and the strengthening rib 12a is formed in order to improve the rigidity of the base. Thus, the weight and the thickness of the arrangement can be reduced, and the desired strength can be securely ensured. Further, according to Embodiment 1, the arrangement has a high mass productivity and the production cost can be reduced.

### Embodiment 2

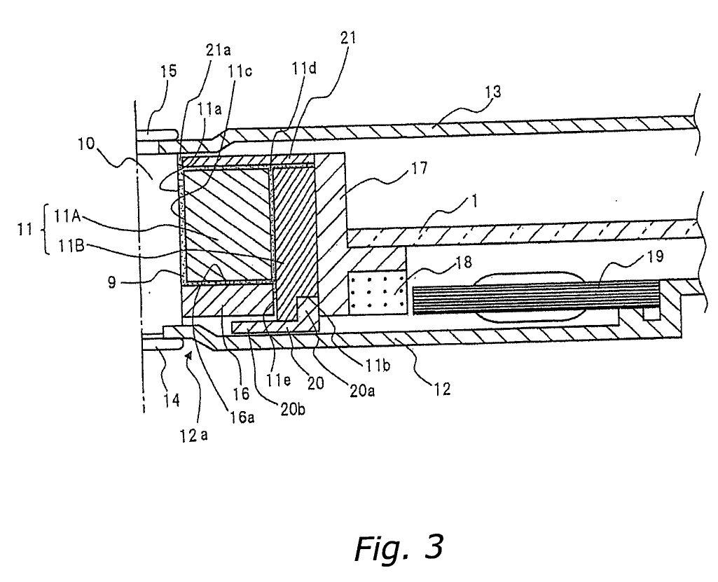

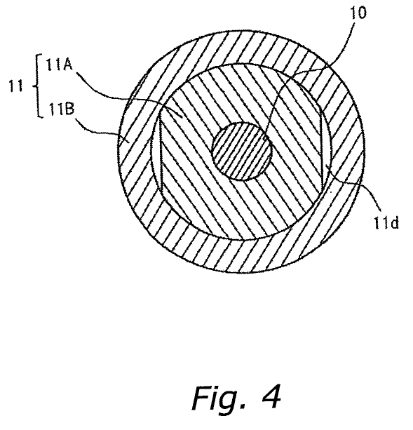

A motor for a disc driving apparatus which uses a hydrodynamic bearing device of Embodiment 2 according to the present invention will be described with reference to FIGS. 3 and 4. FIG. 3 is a cross-sectional view of a right half of the motor for the disc driving apparatus which uses the hydrodynamic bearing device of Embodiment 2 showing the structure thereof. FIG. 4 is a plan view showing the shaft and the sleeve which form a bearing portion in the motor for the disc driving apparatus of Embodiment 2. In FIGS. 3 and 4, the parts having the same functions and the structures as those of Embodiment 1 are denoted by the same reference numerals, and the description thereof is omitted.

The motor for the disc driving apparatus which uses the hydrodynamic bearing device of Embodiment 2 is different from the motor for the disc driving apparatus of Embodiment 1 in the structure of the sleeve. The remaining part of the structure is same as that of Embodiment 1.

As shown in FIGS. 3 and 4, in the motor for the disc driving apparatus of Embodiment 2, the sleeve 11 is formed of two parts. The firs part, an inner sleeve 11A has the bearing hole Ha through which the shaft 10 penetrates. An outer sleeve 11B is attached to an outer peripheral surface of the inner sleeve 11A. The outer sleeve 11B is formed to have a hollow cylindrical shape. A notch portion formed on the outer peripheral surface of the inner sleeve 11A forms the communication hole 11d.

The inner sleeve 11A is formed to have a length along the rotation axis shorter than that of the outer sleeve 11B. An upper end surface of the inner sleeve 11A is substantially flush with an upper end surface of the outer sleeve 11B. The thrust plate 16 is positioned so as to oppose a lower end surface of the inner sleeve 11A, and is provided within a lower space formed by the inner sleeve 11A and the outer sleeve 11B. A step portion lib is formed on a lower end surface of the outer sleeve 11B, and the retaining plate 20 for retaining the shaft is fixed thereto. To a part of the upper end surface of the outer sleeve 11B, the seal plate 21 is fixed.

The motor for the disc driving apparatus of Embodiment 2 having the above-described structure has the same effects as the motor for the disc driving apparatus of Embodiment 1. Further, since the sleeve 11 can be formed of two parts having a simple shape, the sleeves can be processed with high precisions, and motors with a high reliability can be readily assembled and produced.

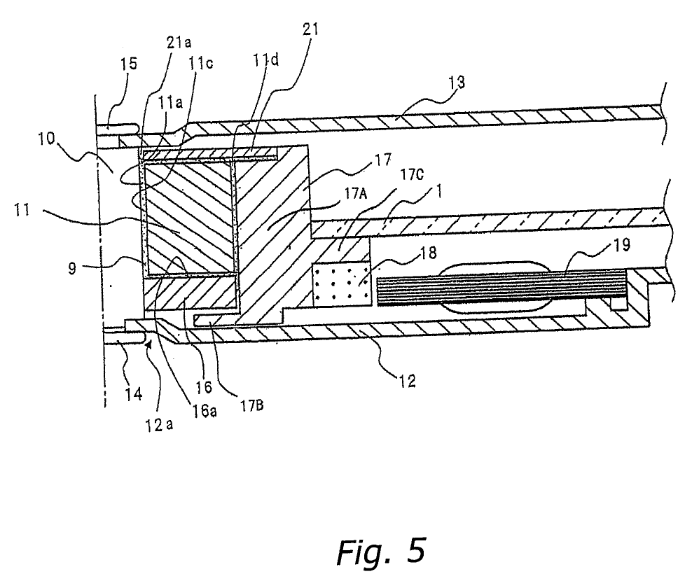

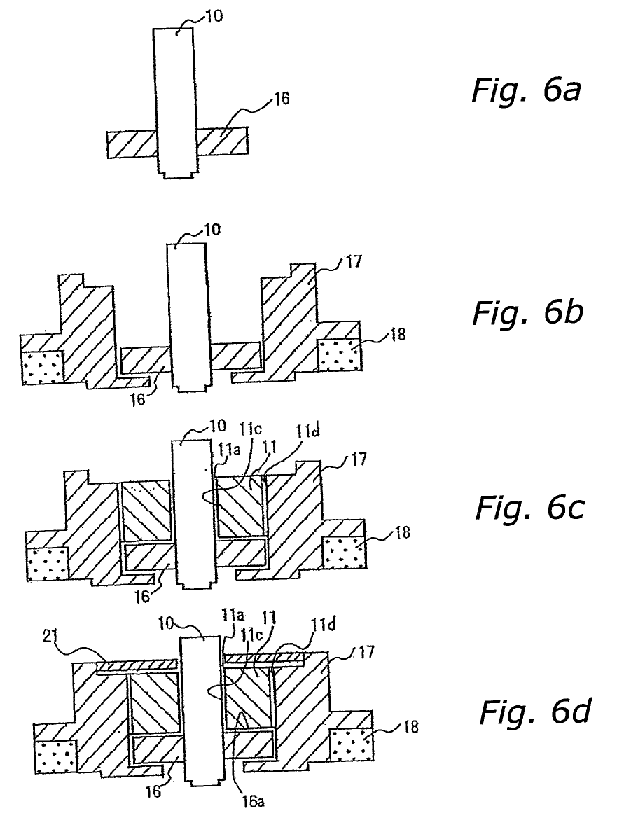

A motor for a disc driving apparatus which uses a variant of the hydrodynamic bearing device of Embodiment 2 will be described with reference to FIGS. 5 and 6. FIG. 5 is a cross-sectional view of a right half of the motor for a disc driving apparatus which uses a variant of the hydrodynamic bearing device of Embodiment 2 showing the structure thereof. FIG. 6A through 6D are diagrams illustrating a method for assembling the variant of the hydrodynamic bearing device of Embodiment 2. In FIGS. 5 and 6, parts having the same functions and structures as those in Embodiments 1 and 2 are denoted by the same reference numerals, and the description thereof is omitted.

In the motor for the disc driving apparatus which uses the variant of the hydrodynamic bearing device of Embodiment 2, the outer sleeve 11B, the retaining plate 20, and the rotor hub 17 in the motor for the disc driving apparatus of Embodiment 2 are integrally formed and forms one rotor hub 17. The remaining part of the structure is substantially same as those of the above-described embodiments.

As shown in FIG. 5, in the variant of the motor for the disc driving apparatus, a sleeve 11 has the structure similar to that of the inner sleeve 11A shown in FIG. 3. Specifically, the sleeve 11 has a substantially cylindrical shape and has the bearing hole Ha through which the shaft 10 penetrates. On the outer peripheral surface of the sleeve 11, the inner peripheral surface of the rotor hub 17 is fixed. On the outer peripheral surface of the sleeve 11, a notch portion is formed at at least one position in a circumferential direction. The notch portion and the inner peripheral surface of the rotor hub 17 form the communication hole 11d.

The rotor hub 17 is formed to have a shape such that the outer sleeve 11B, the retaining plate 20 and the rotor hub 17 shown in FIG. 3 are integrally formed. Specifically, main components of the rotor hub 17 are: a side portion 17A having an inner peripheral surface which opposes the outer peripheral surfaces of the sleeve 11 and the thrust plate 16; a retaining portion 17B provided under the side portion 17A and has an axial direction surface elongated inward in a radial direction from the lower end of the inner peripheral surface of the side portion 17A; and a flange portion 17C having a ring shape which is protruded outward in the radial direction from an outer peripheral surface of the side portion 17A.

The inner peripheral surface of the side portion 17A has a length in axial direction slightly longer than that of the sleeve 11 plus that of the thrust plate 16. The sleeve 11 is fixed so as to fit in the inner peripheral surface of the side portion 17A. The upper end surface of the sleeve 11 is substantially flush with the upper end surface of the side portion 17A. Thus, a ring space having a length in axial direction slightly longer than the length in axial direction of the thrust plate 16 is formed between the lower end surface of the sleeve 11 and the axial direction surface of the retaining portion 17B. The thrust plate 16 is positioned such that the outer peripheral surface is within the ring space. The thrust plate 16 is positioned with its upper end surface opposing the lower end surface of the sleeve 11 and its lower end surface opposing the axial direction surface of the retaining portion 17B. Such a structure allows the sleeve 11 and the rotor hub 17 to be relatively rotatable with respect to the thrust plate 16 and, at the same time, the relative motion in the axial direction with respect to the thrust plate 16 is restricted.

On an upper side of the flange portion 17C, the disc 1 is attached. To a lower side of the flange portion 17C, the rotor magnet 18 is fixed.

On a part of the outer peripheral of the upper end surface of the rotor hub 17, a protrusion having a ring shape which is protruded in the axial direction is formed. The seal plate 21 is fixed so as to fit in the inner peripheral surface of the protrusion.

Next, a method for assembling the variant of the hydrodynamic bearing device which has the above-described structure will be described with reference to FIGS. 6A through 6D.

FIGS. 6A through 6D are schematic views for illustrating a method for assembling the variant of the hydrodynamic bearing device. The variant of the hydrodynamic bearing device is assembled as sequentially shown by FIGS. 6A through 6D. FIG. 6A shows the thrust plate 16 fixed to the shaft 10 by press fit (or insertion) and an adhesive. In some cases, the shaft 10 is integrally formed with the thrust plate 16. As shown in FIG. 6B, the shaft 10 having the thrust plate 16 fixed thereto is positioned inside the rotor hub 17 as described with reference to FIG. 5. At this time, the lower end of the shaft 10 is inserted through a hole formed by the inner peripheral surface of the retaining portion 17B of the rotor hub 17, and the lower end surface of the thrust plate 16 is positioned so as to oppose the axial direction surface of the retaining portion 17B of the rotor hub 17. Before or after this step, the rotor magnet 18 is fixed to the rotor hub 17. Then, the sleeve 11 is inserted from the side of the upper end surface of the shaft 10, and fixed to the inner peripheral surface of the rotor hub 17 by press fit and an adhesive (see FIG. 6C). At this time, the sleeve 11 is press-fit until the level of the upper end surface in the axial direction matches the level of the upper end surface of the rotor hub 17 in the axial direction. Next, the seal plate 21 is fixed to the rotor hub 17 with a gap of a predetermined distance to the upper end surface of the sleeve 11 being secured (see FIG. 6D). Specifically, the seal plate 21 is fixed and filled into the inner peripheral surface of the ring protrusion provided on the upper end surface of the rotor hub 17. For fixing the seal plate 21, press fit and an adhesive is used.

In the hydrodynamic bearing device assembled and produced as described above, the base 12 of a metal plate is fixed to the lower end of the shaft 10 with the screw 14. The disc 1 is attached to the rotor hub 17, and is fixed to the rotor hub 17 by a clamp member. Finally, the cover 13 is fixed to the upper end of the shaft 10 with the screw 15, and the motor for the disc driving apparatus which uses the variant of the hydrodynamic bearing device is completed.

The variant of the motor for a disc driving apparatus which has the above-described structure has the same effects as the motors for the disc driving apparatuses of Embodiments 1 and 2. Moreover, it can be formed with fewer parts. Thus, the production cost and production steps can be reduced.

(Other)

In the hydrodynamic bearing devices of Embodiments 1 and 2, a predetermined space is formed between the sleeve 11 and the seal plate 21 positioned on the upper end surface thereof to form the oil reserver. The space for such an oil reserver can be enlarged. For example, a recessed portion may be formed on one or both of the surfaces of the sleeve 11 and the seal plate 21 which oppose each other to increase the space for the oil reserver.

In the hydrodynamic bearing devices of Embodiments 1 and 2, the rotor hub 17 is directly fixed to the outer peripheral surface of the sleeve 11. However, an intermediate member may be provided between the sleeve and the hub in order to integrally form the shaft 10, the sleeve 11, the thrust plate 16, the retaining plate 20, the seal plate 21, and the lubricating oil 9 as a bearing member using the intermediate member. Providing an intermediate member and forming the bearing member as one unit, the step of attachment to the motor and the disc driving apparatus is facilitated, and a high working property can be achieved.

According to the present invention, as specifically described with reference to the above embodiments, significant effects can be achieved. Therefore, according to the present invention, miniaturization, and reduction of the weight and the thickness can be achieved. Thus, it becomes possible to provide the hydrodynamic bearing device having the high reliability, mass productivity and operating efficiency, and the motor and the disc driving apparatus using the same.

The preferred embodiments of the present invention have been described above in detail to a certain degree. However, the disclosure of the preferred embodiments should be modified in details of the structure. Altering the combination or the order of the components can be implemented without departing from the scope and the sprit of the claims of the present invention.

The hydrodynamic bearing device according to the present invention allows miniaturization and reduction in the weight and thickness. Thus, the hydrodynamic bearing device is useful in equipment which employs such an arrangement.

What is claimed is:

1. A hydrodynamic bearing device, comprising:
a shaft;
a sleeve through which the shaft penetrates, which has a first opposing surface substantially orthogonal to a central axis of the shaft at one end and a second opposing surface at the other end, which has at least one communication path between the first opposing surface and the second opposing surface, and which is relatively rotatable with respect to the shaft;
a thrust plate having a disc shape which is fixed near one end of the shaft or which is integrally formed with the shaft and which has a first surface opposing the first opposing surface of the sleeve;
a seal plate which is positioned near other end of the shaft and which is integrally rotatable with the sleeve having a gap to the second opposing surface of the sleeve;
a retaining portion which is fixed to the sleeve and is positioned so as to oppose a second surface of the thrust plate, which is an end surface opposite to the first surface;
a radial direction dynamic pressure generating portion which is formed on at least one of the surfaces of the shaft and the sleeve which oppose each other;
a thrust direction dynamic pressure generating portion which is formed on at least one of the surfaces of the thrust plate and the sleeve which oppose each other; and
a lubricant which is held in a small gap of the radial direction dynamic pressure generating portion and the thrust direction dynamic pressure generating portion.

2. A hydrodynamic bearing device according to claim 1, wherein the sleeve includes a first member through which the shaft penetrates and a second member fixed to an outer peripheral surface of the first member, having at least one communication path which is substantially parallel to a central axis of the shaft formed between the first member and the second member.

3. A hydrodynamic bearing device according to claim 1, wherein the sleeve includes a first member through which the shaft penetrates and a second member fixed to an outer peripheral surface of the first member and integrally formed with the retaining portion.

4. A hydrodynamic bearing device according to claim 1, wherein a recessed portion is formed on at least one of surfaces of the sleeve and the seal plate which oppose each other.

5. A motor, comprising:
a shaft;
a sleeve through which the shaft penetrates, which has a first opposing surface substantially orthogonal to a central axis of the shaft at one end and a second opposing surface at the other end, which has at least one communication path between the first opposing surface and the second opposing surface, and which is relatively rotatable with respect to the shaft;
a thrust plate having a disc shape which is fixed near one end of the shaft or which is integrally formed with the shaft and which has a first surface opposing the first opposing surface of the sleeve;
a base fixed to the one end of the shaft;
a seal plate which is positioned near other end of the shaft and which is integrally rotatable with the sleeve having a gap to the second opposing surface of the sleeve;
a retaining portion which is fixed to the sleeve and is positioned so as to oppose a second surface of the thrust plate, which is an end surface opposite to the first surface;
a radial direction dynamic pressure generating portion which is formed on at least one of the surfaces of the shaft and the sleeve which oppose each other;
a thrust direction dynamic pressure generating portion which is formed on at least one of the surfaces of the thrust plate and the sleeve which oppose each other;
a lubricant which is held in a small gap of the radial direction dynamic pressure generating portion and the thrust direction dynamic pressure generating portion;
a motor rotor portion substantially fixed to the sleeve; and
a motor stator portion positioned so as to oppose the motor rotor portion and fixed to the base.

6. A motor according to claim 5, wherein a base formed by pressing a metal plate is formed to have a bent portion so as to function as a rib for improving rigidity.

7. A motor according to claim 5, wherein a bent portion is formed near a portion of the base fixed to the shaft and at least a part of the retaining portion is positioned in a space formed by the bent portion.

8. A motor according to claim 5, wherein the base is fixed to the one end of the shaft by a fixing portion, a bent portion is formed near a portion of the base which is fixed to the shaft, and at least a part of the portion which is fixed is positioned in a recessed space formed by the bent portion such that the fixing portion is not protruded outside the motor from a surface formed by the base.

9. A motor according to claim 5, wherein the motor rotor portion is a magnet and the motor stator portion is a core.

10. A motor according to claim 9, wherein the motor rotor portion is positioned near the base such that a magnetic attraction of the motor rotor portion generates a suction force toward the base.

11. A motor according to claim 9, wherein the motor rotor portion and the motor stator portion are in offset positions such that the motor rotor portion is sucked toward the base.

12. A motor according to claim 5, wherein the sleeve includes a first member through which the shaft penetrates and a second member fixed to the outer peripheral surface of the first member and integrally formed with the retaining portion.

13. A disc driving apparatus, comprising:
a shaft;
a sleeve through which the shaft penetrates, which has a first opposing surface substantially orthogonal to a central axis of the shaft at one end and a second opposing surface at the other end, which has at least one communication path between the first opposing surface and the second opposing surface, and which is relatively rotatable with respect to the shaft;
a thrust plate having a disc shape which is fixed near one end of the shaft or which is integrally formed with the shaft and which has a first surface opposing the first opposing surface of the sleeve;
a base fixed to the one end of the shaft and formed of a metal plate;
a seal plate which is positioned near other end of the shaft and which is integrally rotatable with the sleeve having a gap to the second opposing surface of the sleeve;
a retaining portion, which is fixed to the sleeve and is positioned so as to oppose a second surface of the thrust plate, which is an end surface opposite to the first surface;
a radial direction dynamic pressure generating portion which is formed on at least one of the surfaces of the shaft and the sleeve which oppose each other;
a thrust direction dynamic pressure generating portion which is formed on at least one of the surfaces of the thrust plate and the sleeve which oppose each other;
a lubricant which is held in a small gap of the radial direction dynamic pressure generating portion and the thrust direction dynamic pressure generating portion;
a hub which is fixed to an outer peripheral surface of the sleeve and to which a recording medium of a disc shape is attached;
a motor rotor portion fixed to the hub; and
a motor stator portion positioned so as to oppose the motor rotor portion and fixed to the base.

14. A disc driving apparatus according to claim 13, wherein an intermediate member is provided between the sleeve and the hub, and the shaft, the sleeve, the thrust plate, the seal plate, the retaining portion, the radial direction dynamic pressure generating portion, the thrust direction dynamic pressure generating portion, and the lubricant are integrally formed as a bearing member using the intermediate member.

15. A disc driving apparatus according to claim 13, wherein the retaining portion and the hub are integrally formed.

16. A method for producing a hydrodynamic bearing device, comprising the steps of:
forming a radial direction dynamic pressure generating portion on at least one of surfaces of a shaft and a sleeve which oppose each other;
forming a thrust direction dynamic pressure generating portion on at least one of surfaces of a thrust plate of a disc shape and the sleeve which oppose each other;
inserting the sleeve so as to be relatively rotatable with respect to the shaft such that the first surface of the thrust plate orthogonal to a central axis of the shaft opposes a first opposing surface of the sleeve;
positioning a retaining portion so as to oppose a second surface of the thrust plate which is an end surface opposite to the first surface and fixing the retaining portion to the sleeve; and
positioning a seal plate which is integrally rotatable with the sleeve near the other end of the shaft having a gap to a second opposing surface of the sleeve which is an end surface opposite to the first opposing surface and fixing the seal plate to a hub fixed to an outer peripheral surface of the sleeve so as to be integrally rotatable with the sleeve.

17. A method for producing a hydrodynamic bearing device, comprising the steps of:
forming a radial direction dynamic pressure generating portion on at least one of surfaces of a shaft and a sleeve which oppose each other;
forming a thrust direction dynamic pressure generating portion on at least one of surfaces of a thrust plate of a disc shape and the sleeve which oppose each other;
positioning the shaft and the thrust plate provided near one end of the shaft inside a hub including a side portion which has a ring inner peripheral surface and a bottom portion which is provided on one end of the side portion and has a hole having a diameter smaller than that of the inner peripheral surface, with the one end of the shaft penetrating through the hole and a second surface of the thrust plate which is orthogonal to a central axis of the shaft opposing an axial direction surface of the bottom portion;
fitting the sleeve in the ring inner peripheral surface of the hub such that the sleeve is penetrated from the side of the other end of the shaft, and a first opposing surface of the sleeve opposes a first surface of the thrust plate which is an end surface opposite to the second surface; and
positioning a seal plate which is integrally rotatable with the sleeve near the other end of the shaft having a gap to a second opposing surface of the sleeve which is an end surface opposite to the first opposing surface and fixing the seal plate to the hub fixed to an outer peripheral surface of the sleeve so as to be integrally rotatable with the sleeve.
